(19) United States
(12) Patent Application Publication
(10) Pub. No.: US 2025/0054516 A1
(43) Pub. Date: Feb. 13, 2025

(54) OPTICAL RECORDING MEDIUM, METHOD FOR RECORDING INFORMATION, AND METHOD FOR READING INFORMATION

(71) Applicant: Panasonic Intellectual Property Management Co., Ltd., Osaka (JP)

(72) Inventors: SHINJI ANDO, Osaka (JP); MASAKO YOKOYAMA, Osaka (JP); KOTA ANDO, Osaka (JP); YUKI OHARA, Osaka (JP); HIDEKAZU ARASE, Hyogo (JP)

(21) Appl. No.: 18/922,530

(22) Filed: Oct. 22, 2024

Related U.S. Application Data
(63) Continuation of application No. PCT/JP2023/012102, filed on Mar. 27, 2023.

(30) Foreign Application Priority Data
May 17, 2022 (JP) 2022-081188

(51) Int. Cl. G11B 7/245; C08G 73/06

(52) U.S. Cl. CPC G11B 7/245; C08G 73/0694

(57) ABSTRACT

An optical recording medium of an aspect of the present disclosure includes a recording layer and a dielectric layer positioned on the recording layer and containing a porous organic structural body. A method for recording information of an aspect of the present disclosure includes preparing a light source emitting light having a wavelength of longer than or equal to 390 nm and shorter than or equal to 420 nm and focusing the light from the light source and applying the light to the recording layer of the optical recording medium.

### BACKGROUND

### 1. Technical Field

The present disclosure relates to an optical recording medium, a method for recording information, and a method for reading information.

### 2. Description of the Related Art

As a technique for increasing the recording capacity of optical information recording media, three-dimensional recording is known, which records information in a multilayered body. In the field of three-dimensional recording, to improve recording density, a finer focus spot is required to be achieved. From the viewpoint of the diffraction limit of focused laser light, to achieve a finer focus spot, laser light having a short wavelength is used. Examples of this laser light include laser light having a central wavelength of 405 nm, which is the standard of Blu-ray (registered trademark) Disc. Thus, optical recording media using the laser light having a central wavelength of 405 nm are known.

Optical recording media include, for example, a recording layer and a dielectric layer positioned on the recording layer (for example, Japanese Patent No. 6448042). In Japanese Patent No. 6448042, the optical recording medium including the recording layer containing the optical information recording material can perform hologram recording.

### SUMMARY

In conventional technologies, there is room for improving the recording sensitivity of optical recording media.

In one general aspect, the techniques disclosed here feature an optical recording medium including a recording layer and a dielectric layer positioned on the recording layer and containing a porous organic structural body.

The present disclosure provides an optical recording medium with improved recording sensitivity.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of an optical recording medium according to an embodiment of the present disclosure;

FIG. 2A is a flowchart about a method for recording information using the optical recording medium according to the embodiment of the present disclosure;

FIG. 2B is a flowchart about a method for reading information using the optical recording medium according to the embodiment of the present disclosure; and

FIG. 3 is a graph of a solid 13C-NMR spectrum of a polymer of intrinsic microporosity used in examples.

### DETAILED DESCRIPTIONS

### Underlying Knowledge Forming Basis of the Present Disclosure

Multilayer optical recording media are especially attracting attention as low-cost, large-capacity optical recording media. A multilayer optical recording medium is, for example, a recording device in which recording layers containing a dye and dielectric layers containing a polymer are alternately stacked on each other. The dye of the recording layers, for example, has nonlinear optical characteristics. The polymer of the dielectric layers is typically a nonporous polymer. When the dye having nonlinear optical characteristics is used as the material of the recording layers, the properties of the recording layers can be changed space-selectively, by which optical memories can be increased in capacity.

In the optical recording medium, the recording layers, for example, contain a resin and a dye generating heat by absorbing light. In the recording layers, the dye absorbs recording light to generate heat. The generated heat propagates to the resin, and the shape or the like of the resin changes, thereby forming a recording mark. Based on light application energy required for the formation of the recording mark, the recording sensitivity of the optical recording medium can be evaluated. Note that the evaluation of the recording sensitivity can also be performed based on a pulse width that correlates with the light application energy.

If the optical recording medium does not include any dielectric layers, and the recording layers are in contact with air, owing to a heat-insulating effect by air, the heat generated in the recording layers is utilized effectively in the recording layers. In this case, the shape changing of the resin easily occurs, thus providing good recording sensitivity. However, when the nonporous dielectric layer is stacked on the recording layer, the heat-insulating effect by air cannot be produced, and the recording layer easily radiates heat. Thus, optical recording media having a stacked structure have a problem of a decrease in recording sensitivity.

The optical recording medium having a stacked structure is, for example, produced by alternately stacking recording layers containing a nonlinear light absorption dye and nonporous dielectric layer on each other. However, in this method, along with the stacking of the dielectric layers, the thermal properties and strength of the recording layers change, and recording sensitivity at an excitation wavelength may significantly decrease.

As described above, as a method achieving low-cost, large-capacity optical recording media, it is considered that the dielectric layer having high light transmissivity against a record reproduction wavelength is introduced onto the recording layer containing the nonlinear light absorption dye, and these layers are alternately stacked on each other. However, conventionally, there have been a tendency that the dielectric layer is stacked, thereby changing heat-insulating properties and mechanical strength for the recording layer and decreasing its recording sensitivity on record reproduction conditions.

The present inventors have conducted study to newly find that a dielectric layer containing a porous organic structural body prevents the decrease in recording sensitivity. This dielectric layer is especially suitable for preventing the decrease in recording sensitivity when light having a wavelength in a short wavelength range is used. In the present specification, the short wavelength range means a wavelength range containing 405 nm and, for example, means a wavelength range of longer than or equal to 390 nm and shorter than or equal to 420 nm. The dielectric layer containing the porous organic structural body is especially suitable for preventing the decrease in recording sensitivity when light having a wavelength near 405 nm is used.

### Summary of Aspect According to Present Disclosure

An optical recording medium according to a first aspect of the present disclosure includes:
a recording layer; and
a dielectric layer positioned on the recording layer and containing a porous organic structural body.

According to the first aspect, the dielectric layer has pores caused by the porous organic structural body. Owing to a heat-insulating effect by air in these pores, for example, heat generated in the recording layer when a recording operation is performed is prevented from being radiated from the recording layer. The heat generated in the recording layer is effectively utilized in the recording layer, thus improving the recording sensitivity of the optical recording medium.

In a second aspect of the present disclosure, for example, in the optical recording medium according to the first aspect, the porous organic structural body may have a specific surface area of greater than or equal to 50 m²/g.

In a third aspect of the present disclosure, for example, in the optical recording medium according to the first or second aspect, the porous organic structural body may have an average pore diameter of greater than or equal to 0.3 nm and less than or equal to 50 nm.

In a fourth aspect of the present disclosure, for example, in the optical recording medium according to any one of the first to third aspects, the porous organic structural body may have an average pore diameter of greater than or equal to 0.3 nm and less than or equal to 3 nm.

The optical recording media according to the second to fourth aspects improve in recording sensitivity.

In a fifth aspect of the present disclosure, for example, in the optical recording medium according to any one of the first to fourth aspects, the porous organic structural body may be a polymer of intrinsic microporosity.

The polymer of intrinsic microporosity described in the fifth aspect, for example, has twisted, rigid main chain skeletons to prevent entanglement among the main chain skeletons. Thus, the dielectric layer containing the polymer of intrinsic microporosity tends to have pores of nanometer size. The nanometer-size porous structure tends to be able to prevent light scattering of record reproduction light. This porous structure produces the heat-insulating effect by air in the pores and is thus also suitable for improving the recording sensitivity of the optical recording medium.

In a sixth aspect of the present disclosure, for example, in the optical recording medium according to the fifth aspect, the polymer of intrinsic microporosity may contain a structural unit represented by Formula (1) below:

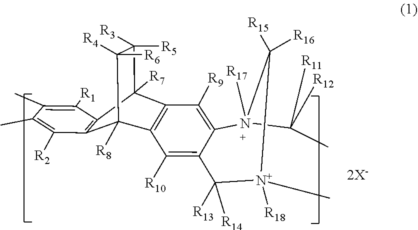

wherein in Formula (1) above, R₁ to R₁₈ mutually independently contain at least one atom selected from the group consisting of H, B, C, N, O, F, Si, P, S, Cl, Br, and I; and X are mutually independently F, Cl, Br, or I.

In a seventh aspect of the present disclosure, for example, in the optical recording medium according to the fifth or sixth aspect, the polymer of intrinsic microporosity may contain a structural unit represented by Formula (2) below:

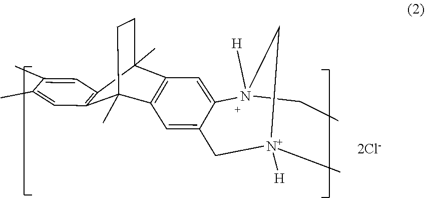

The polymer of intrinsic microporosity described in the sixth and seventh aspects has a short π conjugated system in its main chain skeletons. In this polymer of intrinsic microporosity, the absorption of the record reproduction light tends to be prevented. Furthermore, in this polymer of intrinsic microporosity, a hydrogen atom or a substituent such as an alkyl group is introduced to the nitrogen atom, thereby causing cations. In other words, the polymer of intrinsic microporosity has cationic main chain skeletons. This polymer of intrinsic microporosity has hydrophilicity and is soluble in a highly polar solvent. In this case, it is easy to apply a coating liquid containing the polymer of intrinsic microporosity to the recording layer, which is hydrophobic, to produce the dielectric layer.

In an eighth aspect of the present disclosure, for example, in the optical recording medium according to any one of the first to seventh aspects, the recording layer may contain an organic compound having nonlinear optical characteristics.

In a ninth aspect of the present disclosure, for example, in the optical recording medium according to the eighth aspect, the nonlinear optical characteristics may be two-photon absorption characteristics.

The eighth and ninth aspects can easily increase the recording capacity of the optical recording medium.

A method for recording information according to a 10th aspect of the present disclosure includes:
preparing a light source emitting light having a wavelength of longer than or equal to 390 nm and shorter than or equal to 420 nm; and
focusing the light from the light source and applying the light to the recording layer of the optical recording medium according to any one of the first to ninth aspects.

The 10th aspect can record information in the optical recording medium with high recording density.

A method for reading information according to an 11th aspect of the present disclosure is, for example, a method for reading information recorded by the method of recording according to the 10th aspect, the method of reading including:
measuring an optical characteristic of the recording layer by applying light to the recording layer of the optical recording medium; and
reading information from the recording layer.

In a 12th aspect of the present disclosure, for example, in the method of reading according to the 11th aspect, the optical characteristic may be intensity of light reflected by the recording layer.

The 11th and 12th aspects can easily read information from the optical recording medium.

The following describes an embodiment of the present disclosure with reference to the accompanying drawings. The present disclosure is not limited to the following embodiment.

### EMBODIMENT

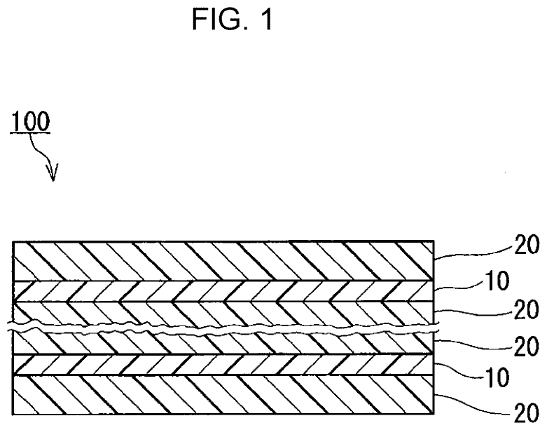

FIG. 1 is a sectional view of a schematic configuration of an optical recording medium 100 according to an embodiment of the present disclosure. As illustrated in FIG. 1, the optical recording medium 100 includes a recording layer 10 and a dielectric layer 20. The dielectric layer 20 is positioned on the recording layer 10 and is, for example, in direct contact with the recording layer 10. The optical recording medium 100 is a stacked structure of the recording layer 10 and the dielectric layer 20. The dielectric layer 20 contains a porous organic structural body.

The optical recording medium 100 may include a plurality of recording layers 10. The recording layers 10 are, for example, arranged in the thickness direction of the optical recording medium 100. In the optical recording medium 100, the number of the recording layers 10, which is not particularly limited, is, for example, greater than or equal to two and less than or equal to 1,000. The optical recording medium 100 including the recording layers 10 functions as a three-dimensional optical memory. A specific example of the optical recording medium 100 is a three-dimensional optical disc.

The dielectric layer 20 may be, for example, an intermediate layer positioned between two recording layers 10. The optical recording medium 100 may include a plurality of dielectric layers 20. In the optical recording medium 100, the recording layers 10 and the dielectric layers 20 may be alternately arranged. In other words, the recording layers 10 and the dielectric layers 20 may be alternately stacked on each other. As an example, the recording layers 10 are each disposed between two dielectric layers 20 and are in direct contact with each of the two dielectric layers 20. In the optical recording medium 100, the number of the dielectric layers 20, which is not particularly limited, is, for example, greater than or equal to three and less than or equal to 1,001.

### Dielectric Layer

As described above, the dielectric layer 20 contains the porous organic structural body. In the present specification, the porous organic structural body means an organic compound having a porous structure. For example, with the organic porous structure, a thin film having a porous structure can be easily formed by a coating method. The coating method is a method of producing a thin film by applying a coating liquid containing the porous organic structural body and drying the obtained coated film. The dielectric layer 20, for example, does not contain any pores formed using a foaming agent. In other words, the dielectric layer 20, for example, does not substantially contain any foamed body.

Examples of the porous organic structural body include a polymer of intrinsic microporosity (PIM), a metal organic framework (MOF), a covalent organic framework (COF), and a hydrogen-bonded organic framework (HOF). The porous organic structural body is, for example, the PIM. The PIM means a porous structural body having a porous structure produced by prevention of entanglement among main chain skeletons of a polymer.

The polymer of intrinsic microporosity contains, for example, a structural unit represented by Formula (1) below:

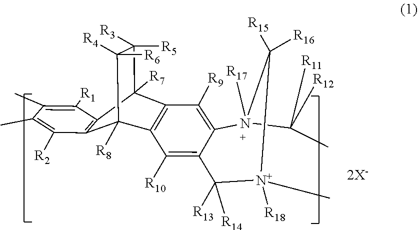

In Formula (1), R₁ to R₁₈ mutually independently contain at least one atom selected from the group consisting of H, B, C, N, O, F, Si, P, S, Cl, Br, and I.

R₁ to R₁₈ may be mutually independently a hydrogen atom, a halogen atom, a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom.

Examples of the halogen atom include F, Cl, Br, and I. In the present specification, the halogen atom may be called a halogen group.

The number of carbon atoms of the hydrocarbon group, which is not particularly limited, is, for example, greater than or equal to one and less than or equal to 20 and may be greater than or equal to one and less than or equal to 10 or greater than or equal to one and less than or equal to five. The hydrocarbon group may be linear, branched, or cyclic.

Examples of the hydrocarbon group include an aliphatic saturated hydrocarbon group, an alicyclic hydrocarbon group, and an aliphatic unsaturated hydrocarbon group. The aliphatic saturated hydrocarbon group may be an alkyl group. Examples of the aliphatic saturated hydrocarbon group include —CH₃, —CH₂CH₃, —CH₂CH₂CH₃, —CH(CH₃)₂, —CH(CH₃)CH₂CH₃, —C(CH₃)₃, —CH₂CH(CH₃)₂, —(CH₂)₃CH₃, —(CH₂)₄CH₃, —C(CH₂CH₃)(CH₃)₂, —CH₂C(CH₃)₃, —(CH₂)₅CH₃, —(CH₂)₆CH₃, —(CH₂)₇CH₃, —(CH₂)₈CH₃, —(CH₂)₉CH₃, —(CH₂)₁₀CH₃, —(CH₂)₁₁CH₃, —(CH₂)₁₂CH₃, —(CH₂)₁₃CH₃, —(CH₂)₁₄CH₃, —(CH₂)₁₅CH₃, —(CH₂)₁₆CH₃, —(CH₂)₁₇CH₃, —(CH₂)₁₈CH₃, and —(CH₂)₁₉CH₃. Examples of the alicyclic hydrocarbon group include a cyclopropyl group, a cyclobutyl group, a cyclopentyl group, a cyclohexyl group, and an adamantyl group. Examples of the aliphatic unsaturated hydrocarbon group include —CH═CH₂, —C≡CH, —C≡CCH₃, —C(CH₃)═CH₂, —CH═CHCH₃, and —CH₂CH═CH₂.

The halogenated hydrocarbon group means a group in which at least one hydrogen atom contained in a hydrocarbon group is replaced by a halogen atom. The halogenated hydrocarbon group may be a group in which all the hydrogen atoms contained in the hydrocarbon group may be replaced by halogen atoms. Examples of the halogenated hydrocarbon group include a halogenated alkyl group and a halogenated alkenyl group.

Examples of the halogenated alkyl group include —CF₃, —CH₂F, —CH₂Br, —CH₂Cl, —CH₂I, and —CH₂CF₃. Examples of the halogenated alkenyl group include —CH═CHCF₃.

The group containing an oxygen atom is, for example, a substituent having at least one selected from the group consisting of a hydroxy group, a carboxy group, an aldehyde group, an ether group, an acyl group, and an ester group.

Examples of the substituent having a hydroxy group include a hydroxy group itself and a hydrocarbon group having a hydroxy group. In this substituent, the hydroxy group may be deprotonated to be a state of —O—. Examples of the hydrocarbon group having a hydroxy group include —CH₂OH, —CH(OH)CH₃, —CH₂CH(OH)CH₃, and —CH₂C(OH)(CH₃)₂.

Examples of the substituent having a carboxy group include a carboxy group itself and a hydrocarbon group having a carboxy group. In this substituent, the carboxy group may be deprotonated to be a state of —CO₂⁻. Examples of the hydrocarbon group having a carboxy group include —CH₂CH₂COOH, —C(COOH)(CH₃)₂, and —CH₂CO₂.

Examples of the substituent having an aldehyde group include an aldehyde group itself and a hydrocarbon group having an aldehyde group. Examples of the hydrocarbon group having an aldehyde group include —CH═CHCHO.

Examples of the substituent having an ether group include an alkoxy group, a halogenated alkoxy group, an alkenyloxy group, an oxiranyl group, and a hydrocarbon group having at least one of these functional groups. At least one hydrogen atom contained in the alkoxy group may be replaced by a group containing at least one atom selected from the group consisting of N, O, P, and S. Examples of the alkoxy group include a methoxy group, an ethoxy group, a 2-methoxyethoxy group, a butoxy group, a 2-methylbutoxy group, a 2-methoxybutoxy group, a 4-ethylthiobutoxy group, a pentyloxy group, a hexyloxy group, a heptyloxy group, an octyloxy group, a nonyloxy group, a decyloxy group, an undecyloxy group, a dodecyloxy group, a tridecyloxy group, a tetradecyloxy group, a pentadecyloxy group, a hexadecyloxy group, a heptadecyloxy group, an octadecyloxy group, a nonadecyloxy group, an cicosyloxy group, —OCH₂O⁻, —OCH₂CH₂O⁻, and —O(CH₂)₃O⁻. Examples of the halogenated alkoxy group include —OCHF₂, —OCH₂F, and —OCH₂Cl. Examples of the alkenyloxy group include —OCH═CH₂. Examples of the hydrocarbon group having a functional group such as an alkoxy group include —CH₂OCH₃, —C(OCH₃)₃, a 2-methoxybutyl group, and a 6-methoxyhexyl group.

Examples of the substituent having an acyl group include an acyl group itself and a hydrocarbon group having an acyl group. Examples of the acyl group include —COCH₃. Examples of the hydrocarbon group having an acyl group include —CH═CHCOCH₃.

Examples of the substituent having an ester group include an alkoxycarbonyl group, an acyloxy group, and a hydrocarbon group having at least one of these functional groups. Examples of the alkoxycarbonyl group include —COOCH₃, —COO(CH₂)₃CH₃, and —COO(CH₂)₇CH₃. Examples of the acyloxy group include —OCOCH₃. Examples of the hydrocarbon group having a functional group such as an acyloxy group include —CH₂OCOCH₃.

The group containing a nitrogen atom is, for example, a substituent having at least one selected from the group consisting of an amino group, an imino group, a cyano group, an azi group, an amide group, a carbamate group, a nitro group, a cyanamide group, an isocyanate group, and an oxime group.

Examples of the substituent having an amino group include a primary amino group, a secondary amino group, a tertiary amino group, a quarternary amino group, and a hydrocarbon group having at least one of these functional groups. In this substituent, the amino group may be protonated. Examples of the tertiary amino group include —N(CH₃)₂. Examples of the hydrocarbon group having a functional group such as a primary amino group include —CH₂NH₂, —CH₂N(CH₃)₂, —(CH₂)₄N(CH₃)₂, —CH₂CH₂NH₃⁺, —CH₂CH₂NH(CH₃)₂⁺, —CH₂CH₂N(CH₃)₃⁺.

Examples of the substituent having an imino group include an imino group itself and a hydrocarbon group having an imino group. Examples of the imino group include —N═CCl₂.

Examples of the substituent having a cyano group include a cyano group itself and a hydrocarbon group having a cyano group. Examples of the hydrocarbon group having a cyano group include —CH₂CN and —CH═CHCN.

Examples of the substituent having an azi group include an azi group itself and a hydrocarbon group having an azi group.

Examples of the substituent having an amide group include an amide group itself and a hydrocarbon group having an amide group. Examples of the amide group include —CONH₂, —NHCHO, —NHCOCH₃, —NHCOCF₃, —NHCOCH₂Cl, and —NHCOCH(CH₃)₂.

Examples of the hydrocarbon group having an amide group include —CH₂CONH₂ and —CH₂NHCOCH₃.

Examples of the substituent having a carbamate group include a carbamate group itself and a hydrocarbon group having a carbamate group. Examples of the carbamate group include —NHCOOCH₃, —NHCOOCH₂CH₃, and —NHCO₂ (CH₂)₃CH₃.

Examples of the substituent having a nitro group include a nitro group itself and a hydrocarbon group having a nitro group. Examples of the hydrocarbon group having a nitro group include —C(NO₂)(CH₃)₂.

Examples of the substituent having a cyanamide group include a cyanamide group itself and a hydrocarbon group having a cyanamide group. The cyanamide group is represented by —NHCN.

Examples of the substituent having an isocyanate group include an isocyanate group itself and a hydrocarbon group having an isocyanate group. The isocyanate group is represented by —N═C═O.

Examples of the substituent having an oxime group include an oxime group itself and a hydrocarbon group having an oxime group. The oxime group is represented by —CH═NOH.

The group containing a sulfur atom is, for example, a substituent having at least one selected from the group consisting of a thiol group, a sulfide group, a sulfinyl group, a sulfonyl group, a sulfino group, a sulfonic acid group, an acylthio group, a sulfenamide group, a sulfonamide group, a thioamide group, a thiocarbamide group, and a thiocyano group.

Examples of the substituent having a thiol group include a thiol group itself and a hydrocarbon group having a thiol group. The thiol group is represented by —SH.

Examples of the substituent having a sulfide group include an alkylthio group, an alkyldithio group, an alkenylthio group, an alkynylthio group, a thiacyclopropyl group, and a hydrocarbon group having at least one of these functional groups. At least one hydrogen atom contained in the alkylthio group may be replaced by a halogen group. Examples of the alkylthio group include —SCH₃, —S(CH₂)F, —SCH(CH₃)₂, and —SCH₂CH₃. Examples of the alkyldithio group include —SSCH₃. Examples of the alkenylthio group include —SCH═CH₂ and —SCH₂CH═CH₂. Examples of the alkynylthio group include —SC≡CH. Examples of the hydrocarbon group having a functional group such as an alkylthio group include —CH₂SCF₃.

Examples of the substituent having a sulfinyl group include a sulfinyl group itself and a hydrocarbon group having a sulfinyl group. Examples of the sulfinyl group include —SOCH₃.

Examples of the substituent having a sulfonyl group include a sulfonyl group itself and a hydrocarbon group having a sulfonyl group. Examples of the sulfonyl group include —SO₂CH₃. Examples of the hydrocarbon group having a sulfonyl group include —CH₂SO₂CH₃ and —CH₂SO₂CH₂CH₃.

Examples of the substituent having a sulfino group include a sulfino group itself and a hydrocarbon group having a sulfino group. In this substituent, the sulfino group may be deprotonated to be a state of —SO_{2″}.

Examples of the substituent having a sulfonic acid group include a sulfonic acid group itself and a hydrocarbon group having a sulfonic acid group. In this substituent, the sulfonic acid group may be deprotonated to be a state of —SO₃.

Examples of the substituent having an acylthio group include an acylthio group itself and a hydrocarbon group having an acylthio group. Examples of the acylthio group include —SCOCH₃.

Examples of the substituent having a sulfenamide group include a sulfonamide group itself and a hydrocarbon group having a sulfenamide group. Examples of the sulfenamide group include —SN(CH₃)₂.

Examples of the substituent having a sulfonamide group include a sulfonamide group itself and a hydrocarbon group having a sulfonamide group. Examples of the sulfonamide group include —SO₂NH₂ and —NHSO₂CH₃.

Examples of the substituent having a thioamide group include a thioamide group itself and a hydrocarbon group having a thioamide group. Examples of the thioamide group include —NHCSCH₃. Examples of the hydrocarbon group having a thioamide group include —CH₂SC(NH₂)₂⁺.

Examples of the substituent having a thiocarbamide group include a thiocarbamide group itself and a hydrocarbon group having a thiocarbamide group. Examples of the thiocarbamide group include —NHCSNHCH₂CH₃.

Examples of the substituent having a thiocyano group include a thiocyano group itself and a hydrocarbon group having a thiocyano group. Examples of the hydrocarbon group having a thiocyano group include —CH₂SCN.

The group containing a silicon atom is, for example, a substituent having at least one selected from the group consisting of a silyl group and a siloxy group.

Examples of the substituent having a silyl group include a silyl group itself and a hydrocarbon group having a silyl group. Examples of the silyl group include —Si(CH₃)₃, —SiH(CH₃)₂, —Si(OCH₃)₃, —Si(OCH₂CH₃)₃, —SiCH₃(OCH₃)₂, —Si(CH₃)₂OCH₃, —Si(N(CH₃)₂)₃, —SiF(CH₃)₂, —Si(OSi(CH₃)₃)₃, and —Si(CH₃)₂OSi(CH₃)₃. Examples of the hydrocarbon group having a silyl group include —(CH₂)₂Si(CH₃)₃.

Examples of the substituent having a siloxy group include a siloxy group itself and a hydrocarbon group having a siloxy group. Examples of the hydrocarbon group having a siloxy group include —CH₂OSi(CH₃)₃.

The group containing a phosphorus atom is, for example, a substituent having at least one selected from the group consisting of a phosphino group and a phosphoryl group.

Examples of the substituent having a phosphino group include a phosphino group itself and a hydrocarbon group having a phosphino group. Examples of the phosphino group include —PH₂, —P(CH₃)₂, —P(CH₂CH₃)₂, —P(C(CH₃)₃)₂, and —P(CH(CH₃)₂)₂.

Examples of the substituent having a phosphoryl group include a phosphoryl group itself and a hydrocarbon group having a phosphoryl group. Examples of the hydrocarbon group having a phosphoryl group include —CH₂PO(OCH₂CH₃)₂.

The group containing a boron atom is, for example, a substituent having a boronic acid group. Examples of the substituent having a boronic acid group include a boronic acid group itself and a hydrocarbon group having a boronic acid group.

As an example, at least one selected from the group consisting of R₇ and R₈ may be an alkyl group such as a methyl group. At least one selected from the group consisting of R₁₇ and R₁₈ may be a hydrogen atom or an alkyl group such as a methyl group. R₁ to R₆ and R₉ to R₁₆ may be a hydrogen atom.

In Formula (1), X may be mutually independently F, Cl, Br, or I. X may be Cl.

The polymer of intrinsic microporosity may contain a structural unit represented by Formula (2) below:

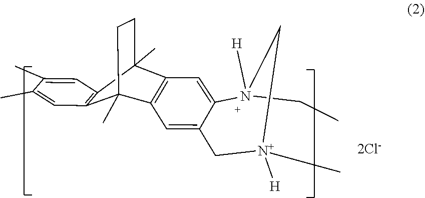

The polymer of intrinsic microporosity, for example, contains the structural unit represented by Formula (1) or the structural unit represented by Formula (2) above as a main component. The polymer of intrinsic microporosity may be represented by Formula (3) or (4) below:

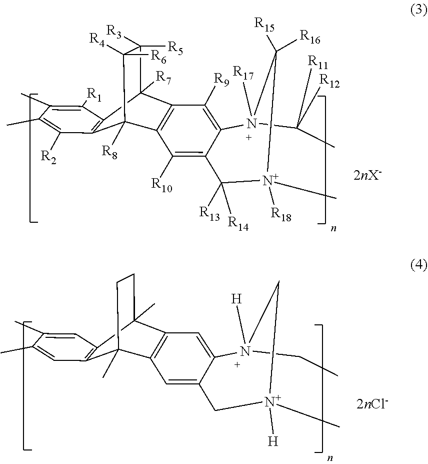

In Formula (3), R₁ to R₁₈ and X are the same as those described above for Formula (1). In Formulae (3) and (4), n is an integer.

The polymer of intrinsic microporosity containing the structural unit represented by Formula (1) or the structural unit represented by Formula (2) above tends to have a short π conjugated system of its main chain skeletons. This polymer of intrinsic microporosity tends to prevent the absorption of record reproduction light. This polymer of intrinsic microporosity tends to especially prevent the absorption of the light having a wavelength in the short wavelength range.

As described above, the porous organic structural body has the porous structure. Thus, when a nitrogen adsorption method is performed for the porous organic structural body, it tends to have a large adsorption amount of nitrogen gas. As an example, an adsorption amount A of nitrogen gas determined by the nitrogen adsorption method for the porous organic structural body is, for example, greater than or equal to 50 cm³/g and may be greater than or equal to 100 cm³/g, greater than or equal to 200 cm³/g, or greater than or equal to 250 cm³/g. The upper limit value of the adsorption amount A, which is not particularly limited, is, for example, 1,000 cm³/g.

The adsorption amount A of nitrogen gas can be identified by the following method. First, nitrogen gas adsorption-desorption measurement is performed on a powdery porous organic structural body. The nitrogen gas adsorption-desorption measurement is performed with a relative pressure P/P₀ adjusted in a range of 0 to 1 on the condition of a temperature of 77 K. Based on a measurement result, an adsorption isotherm curve indicating the relation between the relative pressure P/P₀ and the adsorption amount of nitrogen gas is created. In this process, the adsorption amount of nitrogen gas is converted to a value on the standard temperature and pressure (STP). The adsorption amount of nitrogen gas when the relative pressure P/P₀ is 1 is read from the adsorption isotherm curve, which is identified as the adsorption amount A.

A specific surface area a of the porous organic structural body is, for example, greater than or equal to 50 m²/g and may be greater than or equal to 100 m²/g, greater than or equal to 300 m²/g, or greater than or equal to 500 m²/g. The upper limit value of the specific surface area a, which is not particularly limited, is, for example, 3,000 m²/g. The specific surface area a is obtained by converting the data of the adsorption isotherm curve described above for the adsorption amount A by the Brunauer-Emmett-Teller (BET) method.

An all-pore volume v of the porous organic structural body is, for example, greater than or equal to 0.1 cm³/g and may be greater than or equal to 0.2 cm³/g, greater than or equal to 0.3 cm³/g, or greater than or equal to 0.4 cm³/g. The upper limit value of the all-pore volume v, which is not particularly limited, is, for example, 1.0 cm³/g. The all-pore volume v is obtained by converting the data of the adsorption isotherm curve described above for the adsorption amount A by the Barrett-Joyner-Halenda (BJH) method.

An average pore diameter d of the porous organic structural body is, for example, less than or equal to 50 nm and may be less than or equal to 30 nm, less than or equal to 10 nm, less than or equal to 5 nm, less than or equal to 3 nm, or less than or equal to 2 nm. The porous organic structural body having a small average pore diameter d is suitable for preventing the light scattering of the record reproduction light. The lower limit value of the average pore diameter d, which is not particular limited, is, for example, 0.3 nm. The average pore diameter d may be greater than or equal to 0.3 nm and less than or equal to 50 nm or greater than or equal to 0.3 nm and less than or equal to 3 nm.

The average pore diameter d (nm) of the porous organic structural body can be calculated by substituting the specific surface area a (m²/g) and the all-pore volume v (cm³/g) of the porous organic structural body in the following expression. The average pore diameter d corresponds to the diameter of, when all the pores contained in the porous organic structural body are regarded as one cylindrical pore, the cylindrical pore.

Average pore diameter d=4×10³×all-pore volume v/specific surface area a

The dielectric layer 20, for example, contains the porous organic structural body as a main component. The “main component” means a component contained most in terms of weight ratio in the dielectric layer 20. The dielectric layer 20, for example, consists essentially of the porous organic structural body. “Consisting essentially of . . . ” means excluding other components that change the substantial features of the material referred to. However, the dielectric layer 20 may contain impurities other than the porous organic structural body.

The thickness of the dielectric layer 20, which is not particularly limited, is, for example, greater than or equal to 5 nm and less than or equal to 100 μm. However, the thickness of the dielectric layer 20 may be greater than 100 μm.

Note that the dielectric layer 20 containing the porous organic structural body tends to have high light transmittance against the record reproduction wavelength, especially the wavelength in the short wavelength range. The dielectric layer 20 also tends to achieve both high heat-insulating properties and mechanical strength. As described below, the dielectric layer 20 having heat-insulating properties can improve the recording sensitivity of the optical recording medium 100.

### Recording Layer

The recording layer 10, for example, contains an organic compound C having an optical characteristic. The optical characteristics is typically a light absorption characteristic. As an example, the organic compound C can change from the ground state to a transition state by absorbing the light having a wavelength in the short wavelength range. The organic compound C, when returning to the ground state from the transition state, may generate heat.

The organic compound C may, for example, have nonlinear optical characteristics, especially nonlinear light absorption characteristics. Specifically, the organic compound C may have nonlinear optical characteristics against the light having a wavelength in the short wavelength range. Examples of the nonlinear optical characteristics include two-photon absorption characteristics. However, the organic compound C may have one-photon absorption characteristics against the light having a wavelength in the short wavelength range. In the present specification, the organic compound C having the optical characteristic may be simply called a dye.

The organic compound C contains at least one selected from the group consisting of a carbon-carbon double bond, a carbon-nitrogen double bond, and a carbon-carbon triple bond. The organic compound C may further contain an aromatic ring. The aromatic ring contained in the organic compound C may contain carbon atoms or may be a complex aromatic ring containing hetero atoms such as an oxygen atom, a nitrogen atom, and sulfur atom. Examples of the aromatic ring contained in the organic compound C include a benzene ring, a naphthalene ring, an anthracene ring, a phenanthrene ring, a furan ring, a pyrrole ring, a pyridine ring, and a thiophene ring. The organic compound C may contain a benzene ring as the aromatic ring. The number of aromatic rings contained in the organic compound C, which is not particularly limited, is, for example, greater than or equal to two and may be greater than or equal to three or greater than or equal to five. The upper limit value of the number of aromatic rings, which is not particularly limited, is, for example, 15. In the organic compound C, a plurality of aromatic rings may be linked together via at least one bond selected from the group consisting of a carbon-carbon double bond, a carbon-nitrogen double bond, and a carbon-carbon triple bond. The aromatic rings contained in the organic compound C may be the same as each other or difference from each other.

Specific examples of the organic compound C include Dye 28Ev represented by Formula (5) below. Dye 28Ev is a compound having two-photon absorption characteristics against the light having a wavelength in the short wavelength range.

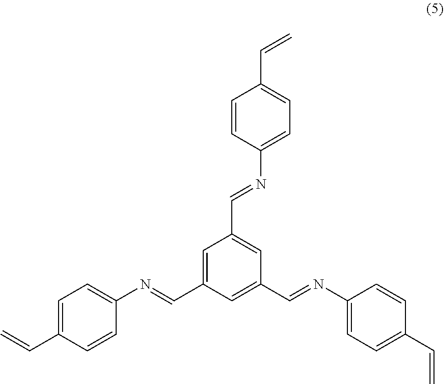 [SMILES: C=Cc1ccc(/N=C/c2cc(/C=N/c3ccc(C=C)cc3)cc(/C=N/c3ccc(C=C)cc3)c2)cc1]

Other examples of the organic compound C include Coumarin 6. Coumarin 6 is a compound having one-photon absorption characteristics against the light having a wavelength in the short wavelength range.

The content of the organic compound C in the recording layer 10 is, for example, less than 50 wt % and may be less than or equal to 30 wt % or less than or equal to 10 wt %. The lower limit value of the content of the organic compound C, which is not particularly limited, is, for example, 2 wt %.

The recording layer 10 may further contain a resin functioning as a binder other than the organic compound C. Specific examples of the resin include polyvinylcarbazole.

The content of the resin in the recording layer 10 is, for example, greater than or equal to 50 wt % and may be greater than or equal to 70 wt % or greater than or equal to 90 wt %. The upper limit value of the content of the resin, which is not particularly limited, is, for example, 98 wt %.

The recording layer 10 is, for example, a thin film having a thickness of greater than or equal to 1 nm and less than or equal to 100 μm. However, the thickness of the recording layer 10 may be greater than 100 μm.

### Method for Producing Optical Recording Medium

The optical recording medium 100 can be produced by, for example, the following method. First, the material of the recording layer 10 is mixed with a solvent to produce a coating liquid. As the solvent, for example, a less polar solvent can be used. This coating liquid is applied to a base by a method such as spin coating, and the obtained coated film is dried to produce the recording layer 10 as a thin film.

Next, the porous organic structural body is mixed with a solvent to produce a coating liquid. As the solvent, a highly polar solvent can be used. This coating liquid is applied onto the recording layer 10 by a method such as spin coating, and the obtained coated film is dried to produce the dielectric layer 20. As needed, the optical recording medium 100 can be obtained by alternately producing a plurality of recording layers 10 and a plurality of dielectric layers 20.

In the polymer of intrinsic microporosity containing the structural unit represented by Formula (1) or the structural unit represented by Formula (2) above, a hydrogen atom or a substituent such as an alkyl group is introduced to the nitrogen atom, thereby causing cations. Owing to this, this polymer of intrinsic microporosity has hydrophilicity and is soluble in a highly polar solvent. In this case, it is easy to apply a coating liquid containing the polymer of intrinsic microporosity to the recording layer, which is hydrophobic, to produce the dielectric layer.

### Method for Using Optical Recording Medium

The optical recording medium 100 of the present embodiment, for example, utilizes the light having a wavelength in the short wavelength range. As an example, the optical recording medium 100 utilizes light having a wavelength of longer than or equal to 390 nm and shorter than or equal to 420 nm. The light utilized for the optical recording medium 100, for example, has high photon density near its focus. The power density of the light utilized for the optical recording medium 100 near its focus is, for example, greater than or equal to 0.1 W/cm² and less than or equal to 1.0×10²⁰ W/cm². The power density of this light near its focus may be greater than or equal to 1.0 W/cm², greater than or equal to 1.0×10² W/cm², or greater than or equal to 1.0×10⁵ W/cm². As a light source utilized for the optical recording medium 100, for example, a femtosecond laser such as a titanium sapphire laser or a pulsed laser having a pulse width of picoseconds to nanoseconds, such as a semiconductor laser, can be used.

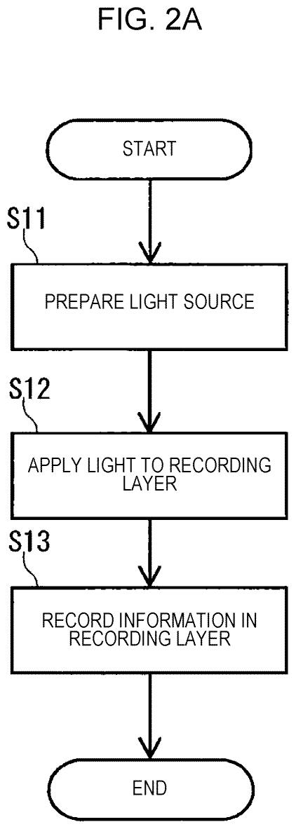

The following describes a method for recording information using the optical recording medium 100. FIG. 2A is a flowchart about the method for recording information using the optical recording medium 100. First, in Step S11, a light source emitting light having a wavelength of longer than or equal to 390 nm and shorter than or equal to 420 nm is prepared. As the light source, for example, a femtosecond laser such as a titanium sapphire laser or a pulsed laser having a pulse width of picoseconds to nanoseconds, such as a semiconductor laser, can be used. Next, in Step S12, the light from the light source is focused with a lens or the like to be applied to the recording layer 10 of the optical recording medium 100. Specifically, the light from the light source is focused with a lens or the like to be applied to a recording area of the optical recording medium 100. The NA (numerical aperture) of the lens for use in focusing is not particularly limited. As an example, a lens with an NA in a range of greater than or equal to 0.8 and less than or equal to 0.9 may be used. The power density of this light near its focus is, for example, greater than or equal to 0.1 W/cm² and less than or equal to 1.0×10²⁰ W/cm². The power density of this light near its focus may be greater than or equal to 1.0 W/cm², greater than or equal to 1.0×10² W/cm², or greater than or equal to 1.0×10⁵ W/cm². In the present specification, the recording area means a spot present in the recording layer 10 and capable of recording information by the application of light.

In the recording area to which the above light has been applied, a physical change or a chemical change occurs, thereby changing an optical characteristic of the recording area. For example, the intensity of the light reflected by the recording area, the reflectance of the light at the recording area, the absorptance of the light at the recording area, the refractive index of the light at the recording area, the light intensity of fluorescence emitted from the recording area, the light wavelength of fluorescence, or the like changes. As an example, the intensity of the light reflected by the recording area or the light intensity of fluorescence emitted from the recording area decreases. This can record information in the recording layer 10, or specifically, the recording area (Step S13).

The following describes a method for reading information using the optical recording medium 100. FIG. 2B is a flowchart about the method for reading information using the optical recording medium 100. First, in Step S21, light is applied to the recording layer 10 of the optical recording medium 100. Specifically, light is applied to the recording area of the optical recording medium 100. The light used in Step S21 may be the same as the light utilized for recording information in the optical recording medium 100 or different therefrom. Next, in Step S22, an optical characteristic of the recording layer 10 is measured. Specifically, an optical characteristic of the recording area is measured. In Step S22, for example, as the optical characteristic of the recording area, the intensity of the light reflected by the recording area or the light intensity of fluorescence emitted from the recording area is measured. In Step S22, as the optical characteristic of the recording area, the reflectance of the light at the recording area, the absorptance of the light at the recording area, the refractive index of the light at the recording area, the light wavelength of fluorescence emitted from the recording area, or the like may be measured. Next in Step S23, information is read from the recording layer 10, or specifically, the recording area.

In the method for reading information, the recording area in which information has been recorded can be searched for by the following method. First, light is applied to a specific area of the optical recording medium. This light may be the same as the light utilized for recording information in the optical recording medium or different therefrom. Next, an optical characteristic of the area to which the light has been applied is measured. Examples of the optical characteristic include the intensity of the light reflected by the area, the reflectance of the light at the area, the absorptance of the light at the area, the refractive index of the light at the area, the light intensity of fluorescence emitted from the area, and the light wavelength of fluorescence emitted from the area. Based on the measured optical characteristic, whether the area to which the light has been applied is the recording area is determined. For example, it is determined that the area is the recording area when the intensity of the light reflected by the area is less than or equal to a specific value. On the other hand, it is determined that the area is not the recording area when the intensity of the light reflected by the area is greater than the specific value. Note that the method for determining whether the area to which the light has been applied is the recording area is not limited to the above method. For example, it may be determined that the area is the recording area when the intensity of the light reflected by the area is greater than a specific value. It may be determined that the area is not the recording area when the intensity of the light reflected by the area is less than or equal to the specific value. When it is determined that the area is not the recording area, the same operation is performed for another area of the optical recording medium. This can search for the recording area.

The method for recording information and the method for reading information using the optical recording medium 100 can be performed by, for example, a known recording apparatus. The recording apparatus includes, for example, a light source applying light to the recording area of the optical recording medium 100, a measuring device measuring the optical characteristic of the recording area, and a controller controlling the light source and the measuring device.

In the optical recording medium 100 of the present embodiment, when the recording light is applied to the recording layer 10, the organic compound C absorbs the recording light to change to the transition state from the ground state. When this organic compound C returns to the ground state from the transition state, for example, heat is generated. With this heat, for example, the binder present in the recording area changes in quality to form the recording mark.

In the optical recording medium 100 of the present embodiment, the dielectric layer 20 has pores caused by the porous organic structural body. Owing to a heat-insulating effect by air in these pores, for example, when a recording operation is performed, the heat generated in the recording layer 10 can be prevented from being radiated from the recording layer 10. The heat generated in the recording layer 10 is effectively utilized in the recording layer 10, thus improving the recording sensitivity of the optical recording medium 100.

The recording sensitivity of the optical recording medium 100 can be, for example, evaluated by the following method. First, using a laser, recording light is applied to the recording layer 10 of the optical recording medium 100. This changes the shape of the resin contained in the recording layer 10 near a focus in which the light from the laser is focused. Minimum light application energy required for causing this change is identified, which is regarded as minimum light application energy required for recording. Based on this light application energy, the recording sensitivity of the optical recording medium 100 can be evaluated. Note that the evaluation of the recording sensitivity may also be performed based on a pulse width that correlates with the light application energy. The optical recording medium 100 of the present embodiment can perform the recording operation with recording light with a relatively shorter pulse width than ever before.

### EXAMPLES

The following describes the present disclosure in more detail with reference to examples. The following examples are by way of example, and the present disclosure is not limited to the following examples.

### Synthesis of Polymer of Intrinsic Microporosity

First, a precursor of a polymer of intrinsic microporosity represented by Formula (6) below (made by Sigma-Aldrich) was prepared:

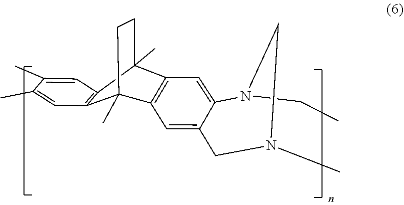

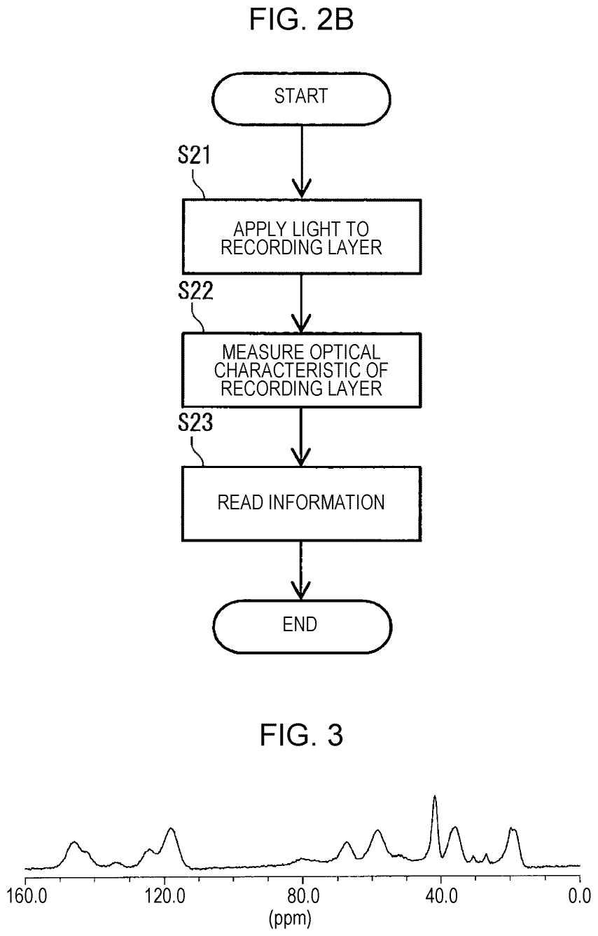

Next, 200 mg of the precursor and 0.2 mL of hydrochloric acid with a concentration of 12 mol/L (made by FUJIFILM Wako Pure Chemical Corporation) were added to 5 mL of diacetone alcohol (made by Tokyo Chemical Industry Co., Ltd.), and the mixture was stirred at 50° C. for 1 hour. This caused the precursor and hydrochloric acid to react with each other, and the polymer of intrinsic microporosity represented by Formula (4) above was synthesized. The reaction liquid was left to cool to room temperature, and diacetone alcohol and hydrochloric acid were distilled off by vacuum distillation to obtain the target polymer of intrinsic microporosity of Formula (4). The polymer of intrinsic microporosity was identified with ¹H-NMR and solid ¹³C-NMR. FIG. 3 is a graph of a solid ¹³C-NMR spectrum of the polymer of intrinsic microporosity. The ¹H-NMR spectrum and the solid ¹³C-NMR spectrum of the polymer of intrinsic microporosity were as follows:

¹H NMR (500 MHz, DMSO d6): δ (ppm) 7.26-6.83 (br, m, 4H), 4.84-4.60 (br, s, 2H), 4.24 (br, s, 4H), 3.47 (br, s), 1.83 (br, m), 1.42 (br, m, 4H). Solid ¹³C NMR: δ (ppm) 158.6-136.7, 130.0-112.1, 80.8, 67.6, 58.2, 41.8, 39.5-32.3, 25.6-14.9.

For the obtained polymer of intrinsic microporosity, the adsorption amount A of nitrogen gas, the specific surface area a, the all-pore volume v, and the average pore diameter d were measured by the above methods. Table 1 lists the results.

TABLE 1

| | | Specific | | Average |
|---|---|---|---|---|
| | Adsorption | surface | All-pore | pore |
| | amount A | area a | volume | diameter |
| | (cm³/g) | (m²/g) | v (cm³/g) | d (nm) |
| Polymer of | 300 | 675 | 0.45 | 2.7 |
| intrinsic | | | | |
| microporosity | | | | |

### Example 1

First, a coating liquid for recording layer containing materials of a recording layer was prepared. Specifically, 1 g of polyvinylcarbazole (PVK) and 105 mg of a coumarin 6 dye were added to 20 mL of dichlorobenzene, and the mixture was heated and stirred at 80° C. for 12 hours to prepare the coating liquid for recording layer. Next, a coating liquid for dielectric layer containing materials of a dielectric layer was prepared. Specifically, 200 mg of the precursor of the polymer of intrinsic microporosity represented by Formula (6) above and 1 mL of hydrochloric acid with a concentration of 12 mol/L were added to 5 ml of diacetone alcohol, and the mixture was stirred at room temperature for 1 hour to prepare the coating liquid for dielectric layer. In the coating liquid for dielectric layer, the polymer of intrinsic microporosity represented by Formula (4) was synthesized.

Next, the coating liquid for recording layer was applied onto a quartz substrate with a spin coater, and the coated film was dried to produce the recording layer. Furthermore, the coating liquid for dielectric layer was applied onto the recording layer with a spin coater, and the dried film was dried to produce the dielectric layer. This obtained an optical recording medium of Example 1 in which the dielectric layer was stacked on the recording layer. In the optical recording medium of Example 1, the dielectric layer had pores caused by the polymer of intrinsic microporosity.

### Example 2

An optical recording medium of Example 2 was obtained in the same manner as in Example 1 except that 53 mg of Dye 28Ev represented by Formula (5) described above was used instead of the coumarin 6 dye.

### Comparative Example 1

An optical recording medium of Comparative Example 1 was obtained in the same manner as in Example 1 except that 1 g of cellulose acetate was added to 24 ml of diacetone alcohol, and the mixture was stirred at 80° C. for 12 hours to prepare the coating liquid for dielectric layer. Note that cellulose acetate does not have any porous structure, and thus in the optical recording medium of Comparative Example 1, the dielectric layer did not have any porous structure. The fact that the layer of cellulose acetate can be stacked on the layer containing polyvinylcarbazole is, for example, disclosed in Thin Solid Films, 2007, Vol. 515, p. 3887-3892 or the like.

### Comparative Example 2

An optical recording medium of Comparative Example 2 was obtained in the same manner as in Comparative Example 1 except that 53 mg of Dye 28Ev represented by Formula (5) described above was used instead of the coumarin 6 dye.

### Measurement of Recording Sensitivity

For the optical recording media of the examples and the comparative examples, one pulse of recording light with a central wavelength of 405 nm and a peak power of 100 mW was applied through a lens with an NA of 0.85 to perform a recording operation. This recording operation was repeatedly performed with the pulse width of the recording light adjusted in a range of 10 nanoseconds to 5 milliseconds. This identified a minimum pulse width required for forming a recording mark in the recording layer. Table 2 lists the results.

TABLE 2

| | | Thermal | | |
|---|---|---|---|---|
| | | conductivity | | Pulse |
| | | of dielectric | Recording | width |
| | Dielectric layer | layer (W/mK) | layer | (nsec) |
| Example 1 | Polymer of intrinsic | 0.11 | PVK/ | 581 |
| | microporosity | | coumarin | |
| Example 2 | Polymer of intrinsic | 0.11 | PVK/ | 554 |
| | microporosity | | 28Ev | |
| Comparative | Cellulose acetate | 0.23 | PVK/ | 795 |
| Example 1 | | | coumarin | |
| Comparative | Cellulose acetate | 0.23 | PVK/ | 743 |
| Example 2 | | | 28Ev | |

As can be seen from Table 2, the optical recording media of the examples including the dielectric layer containing the polymer of intrinsic microporosity as the porous organic structural body had a shorter minimum pulse width required for recording than that of the comparative examples and had improved recording sensitivity.

The optical recording medium of the present disclosure can be utilized for uses such as three-dimensional optical memories.

What is claimed is:

1. An optical recording medium comprising:
a recording layer; and
a dielectric layer positioned on the recording layer and containing a porous organic structural body.

2. The optical recording medium according to claim 1, wherein the porous organic structural body has a specific surface area of greater than or equal to 50 m²/g.

3. The optical recording medium according to claim 1, wherein the porous organic structural body has an average pore diameter of greater than or equal to 0.3 nm and less than or equal to 50 nm.

4. The optical recording medium according to claim 1, wherein the porous organic structural body has an average pore diameter of greater than or equal to 0.3 nm and less than or equal to 3 nm.

5. The optical recording medium according to claim 1, wherein the porous organic structural body is a polymer of intrinsic microporosity.

6. The optical recording medium according to claim 5, wherein the polymer of intrinsic microporosity contains a structural unit represented by Formula (1) below: 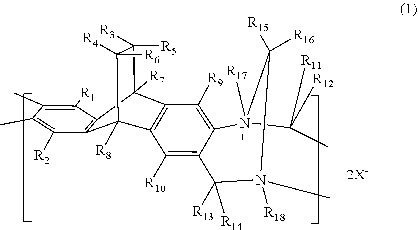
wherein in Formula (1) above, R₁ to R₁₈ mutually independently contain at least one atom selected from the group consisting of H, B, C, N, O, F, Si, P, S, Cl, Br, and I; and X are mutually independently F, Cl, Br, or I.

7. The optical recording medium according to claim 5, wherein the polymer of intrinsic microporosity contains a structural unit represented by Formula (2) below:

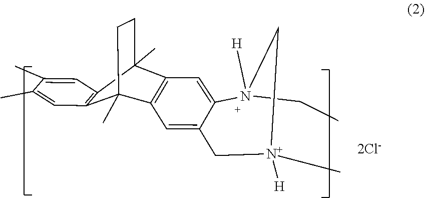

8. The optical recording medium according to claim 1, wherein the recording layer contains an organic compound having nonlinear optical characteristics.

9. The optical recording medium according to claim 8, wherein the nonlinear optical characteristics are two-photon absorption characteristics.

10. A method for recording information comprising:
preparing a light source emitting light having a wavelength of longer than or equal to 390 nm and shorter than or equal to 420 nm; and
focusing the light from the light source and applying the light to the recording layer of the optical recording medium according to claim 1.

11. A method for reading information recorded by the method of recording according to claim 10, the method of reading comprising:
measuring an optical characteristic of the recording layer by applying light to the recording layer of the optical recording medium; and
reading information from the recording layer.

12. The method of reading according to claim 11, wherein the optical characteristic is intensity of light reflected by the recording layer.
